(19) United States
(12) Patent Application Publication
(10) Pub. No.: US 2012/0174677 A1
(43) Pub. Date: Jul. 12, 2012

(54) OPTICAL METHOD AND DEVICE FOR A SPATIALLY RESOLVED MEASUREMENT OF MECHANICAL PARAMETERS, IN PARTICULAR MECHANICAL VIBRATIONS BY MEANS OF GLASS FIBERS

(75) Inventor: Wieland Hill, Odenthal (DE)

(73) Assignee: LIOS TECHNOLOGY GMBH, Koeln (DE)

(21) Appl. No.: 13/499,236

(22) PCT Filed: Sep. 24, 2010
(86) PCT No.: PCT/EP2010/064160

§ 371 Date: Mar. 30, 2012

(30) Foreign Application Priority Data
Sep. 30, 2009 (DE) 10 2009 043 546.8

(51) Int. Cl. G01H 9/00

(52) U.S. Cl. 73/655

(57) ABSTRACT

The invention relates to a device for a spatially-resolved measurement of mechanical parameters, in particular mechanical vibrations, comprising at least one optical fiber (3) for measuring at least one mechanical parameter with spatial resolution, at least one laser light source (1), the light from which can be coupled into the optical fiber (3), wherein in the optical fiber (3), backscattered portions of the light generated by the laser light source (1) can be coupled out of the optical fiber (3), tuning means (2) that can tune the laser light source (1) within a time period of less than 50 ms, detection means that can detect the portions of the backscattered light that are coupled out of the optical fiber (3), and analysis means that can determine at least one mechanical parameter of the optical fiber (3) in a spatially-resolved manner from the captured portions of the backscattered light.

The present invention relates to a method and a device for spatially resolved measurement of mechanical parameters, in particular mechanical vibrations.

Fiber-optic measurement systems for distributed measurement of mechanical quantities in optical waveguides are known in the literature. For example, optical waveguides having a length of up to 80 km can be measured with a spatial resolution of approximately 25 m using a bidirectional interferometer system (US 2008/0191126 A). The spatial resolution is hereby limited by the precision of the phase determination. Other methods use pulsed lasers for determining the position via the propagation time (EP 2 084 505 A and US 2008/297772 A). However, only very weak signals can be obtained due to the small duty factor.

An object of the present invention is a device for fast distributed measurement of mechanical parameters in optical waveguides. Fast measurements are of particular interest when rapid movements or vibrations (seismic, acoustic, mechanical) are to be measured.

The underlying problem of the present invention is to provide a method and a device of the aforedescribed types, which are sensitive and/or enable good spatial resolution.

This is attained according to the invention with respect to the method by a method of the aforedescribed type having the features of claim 1 and with respect to the device by a device of the aforedescribed type having the features of claim 10. The dependent claims relate to preferred embodiments of the invention.

According to claim 1, the method has the following method steps:
generating light with a laser light source;
tuning the laser light source within a time period of less than 50 ms;
coupling the light into an optical fiber (3);
coupling the portions of the light that were coupled into the optical fiber and are backscattered in the optical fiber out of the optical fiber;
measuring the components of the backscattered light coupled out of the optical fiber;
evaluating the measured components of the backscattered light for spatially resolved determination of at least one mechanical parameter of the optical fiber.

According to claim 10, the device includes:
at least one optical fiber for the spatially resolved measurement of at least one mechanical parameter;
at least one laser light source, the light of which can be coupled into the optical fiber, wherein the portions of the light generated by the laser light source and backscattered in the optical fiber can be coupled out of the optical fiber;
tuning means capable of tuning the portions of the backscattered light coupled out of the optical fiber;
analysis means capable of determining from the measured portions of the backscattered light the at least one mechanical parameter of the optical fiber with spatial resolution.

The basic structure may consist of a narrowband, tunable laser light source with a connected optical waveguide. Dividers/combiners for dividing the laser light to the measurement fiber and a reference branch as well as for combining the backscattered light from the measurement fiber with the laser reference portion may be built into the optical fiber. Optionally, polarization-controlling and polarization-spitting components are built in. The backscattered light and reference light are optionally split according to the polarization and guided together to one or two photodetectors. Due to the fast tuning of the laser wavelength or the laser frequency, respectively, the photodetector produces beat signals with frequency components corresponding to the time delay caused by the propagation time in the optical fiber. This so-called OFDR method (Optical Frequency Domain Reflectometry) is generally known and is used for characterizing attenuation and back-reflection in optical waveguides.

The following features are advantageous when using this method for rapid measurement of temporally changing parameters:

A very narrowband laser light source with a long coherence length (e.g. a fiber laser).

A fast wavelength modulator (e.g. fiber Bragg grating with piezo control).

A fast broadband photodetector, optionally with a fast preamplifier and a fast A/D converter.

Fast data processing for frequency analysis and phase analysis (Fourier transform), for example using DSP or FPGA.

Software for analyzing and evaluating temporal changes of the frequency and phase information.

Advantages of the OFDR method are its high signal strength and the attainable ranges and/or sensitivities and the possible high spatial resolution.

The laser light source used with the invention must not necessarily emit light in the visible spectral range, but may in particular also emit long-wavelength radiation in the near infrared spectral range.

Additional features and advantages of the present invention will become clear based on the following description of preferred exemplary embodiments with reference to the appended drawings. These show in:

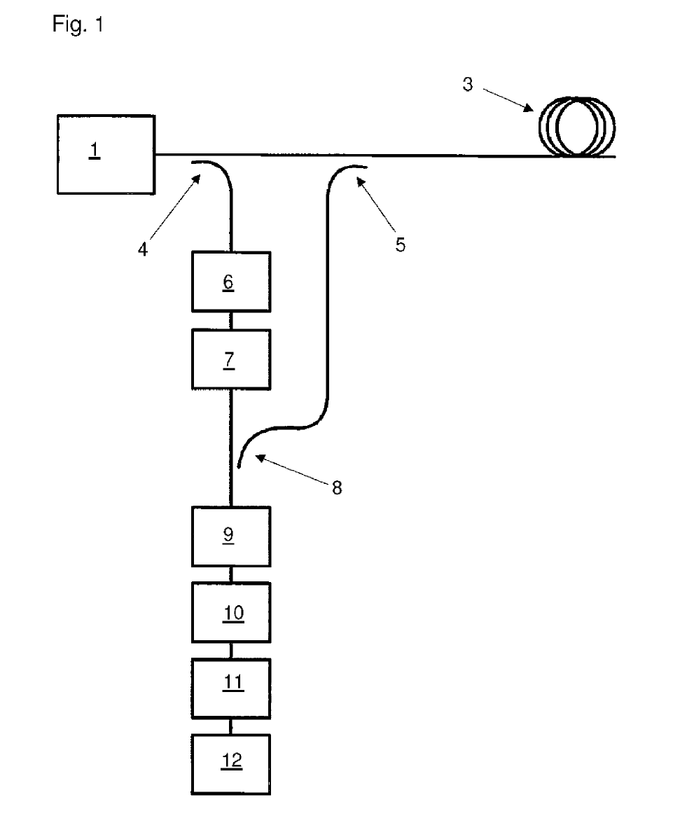

FIG. 1 a schematic diagram of a first embodiment of a device according to the invention;

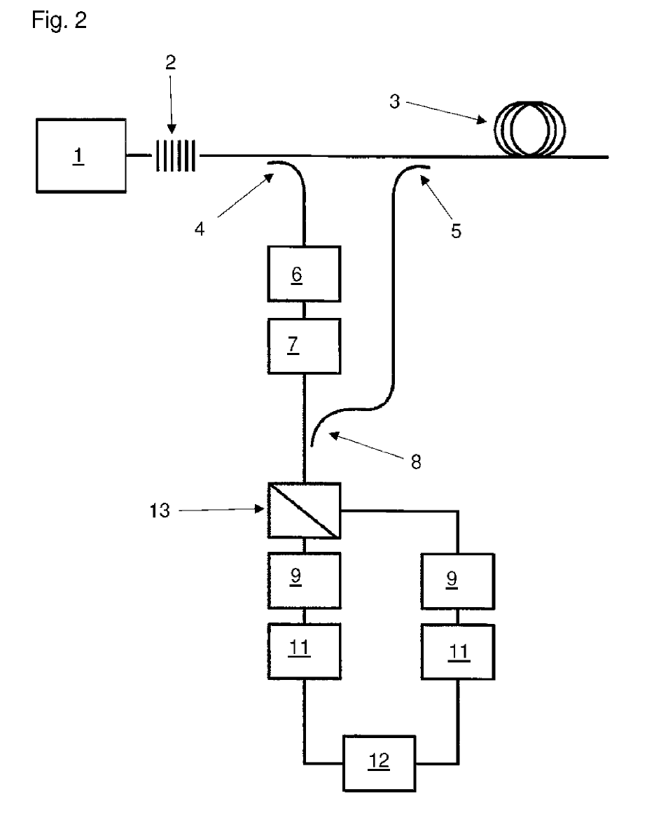

FIG. 2 a schematic diagram of a second embodiment of a device according to the invention.

In FIGS. 1 and 2, identical elements or elements performing an identical function have identical reference symbols.

The first embodiment includes a laser light source 1 with internal (unillustrated) tuning means. Alternatively, the device may include external tuning means 2 for tuning the laser light source 1 (see the second embodiment in FIG. 2).

For example, the laser light source 1 is constructed as a fiber laser. Furthermore, a major portion of the device or the entire device may be based on fiber optics.

Alternatively, the laser light source 1 may be constructed as a wavelength-stabilized, fiber-coupled semiconductor laser (diode laser). Such laser includes a semiconductor crystal which is excited by electric energy and emits laser light into an optical fiber, as well as at least an optical grating. The semiconductor crystal is typically mounted on a Peltier element, which stabilizes and/or regulates the temperature. The wavelength of the laser light is stabilized by way of a grating integrated in the semiconductor crystal (for example, a distributed feedback (DFB) or distributed Bragg reflector (DBR)) or an external grating (for example, a fiber Bragg grating (FBG), a planar waveguides circuit (PWC), a volume phase grating (VPG) or a conventional optical reflection grating) disposed inside the laser resonator. The laser resonator is formed by the end faces of the semiconductor crystal (Fabry-Perot-laser), by two gratings or by a single grating and an end face. At the same time, the grating is used to reduce the optical bandwidth as required for the sensor application.

The laser light source 1 may have a tuning range of the laser frequency of, for example, between 1 GHz and 10 GHz, or a tuning range of the laser wavelength of, for example, 5 pm to 50 pm. Moreover, the laser light source 1 may be extremely narrowband, so that the light exiting the laser light source 1 has a bandwidth of less than 100 kHz. The laser light source 1 can also be constructed so that the coherence length of the light emitted by the laser light source 1 is between 10 km and 100 km.

The tuning means 2 may be, for example, a fiber Bragg grating (FBG) with a piezo-based control. Fast repeated tuning can be performed by mechanically expanding the fiber Bragg grating with a piezo element. The time required for tuning the laser light source 1 over its tuning range may be less than 50 ms, preferably less than 10 ms, in particular less than 5 ms, for example approximately 1 ms.

When the laser light source is constructed as a wavelength-stabilized semiconductor laser, the wavelength can be tuned by varying the grating (period, angle). Like with the aforementioned fiber laser, fast repeated tuning can be accomplished through mechanical expansion of the fiber Bragg grating by a piezo element. Even simpler is tuning by varying the laser current. The laser current affects the temperature and refractive index in the active region of the semiconductor crystal and thus causes the desired fast change of the wavelength. A sawtooth-shaped current can be used for periodic linear tuning of the laser wavelength.

The device also includes an optical fiber 3 operating as a measurement fiber. The optical fiber 3 may have a comparatively large length of, for example, 50 km. The light exiting from the laser light source 1 and/or the tuning means 2 is coupled into the optical fiber 3. Portions of the light are backscattered in the optical fiber 3, for example by Rayleigh scattering. These portions of the light are then again coupled out of the optical fiber 3. Back scattering depends locally on the mechanical parameters in the optical fiber 3 to be measured, so that the portions of the light that are coupled out contain spatially resolved information about these parameters.

Two beam splitters 4, 5 are provided between, on one hand, the laser light source 1 and/or the tuning means 2 and, on the other hand, the optical fiber 3. The first beam splitter 4 separates from the light transmitted in the direction of the optical fiber 3 a portion that can be used as reference light. An attenuator 6 and a polarization rotator 7 are arranged in the reference branch.

The second beam splitter 5 deflects the portions of the light or at least parts of these portions of the light coupled out of the optical fiber 3, in particular downward in FIG. 1. The beam splitter 5 can hereby be implemented, in particular, as a direction-dependent deflection means, for example in form of a polarization beam splitter, or an optical circulator.

The deflected portions from the optical fiber 3 and the reference light are combined in a beam combiner 8 and are together incident on a photodetector 9 serving as detection means. Due to the fast tuning of the laser wavelength and the laser frequency, respectively, the photodetector 9 emits beat signals with frequency components corresponding to the time delay caused by the propagation time in the optical fiber 3.

The signals of the photodetector 9 are supplied to a data processing unit 12 via an amplifier 10 and an A/D converter 11. The data processing unit 12, the amplifier 10 and the A/D converter 11 together with an optional additional (unillustrated) computing unit form the analysis means.

The photodetector 9 may be a fast broadband photodetector. The A/D converter 11 may, for example, operate with a sampling rate of approximately 100 Ms/s (100,000,000 samples per second).

The data processing unit 12 may be implemented, for example, as a digital signal processor (DSP) or as a field programmable gate array (FPGA) and perform a fast frequency analysis and phase analysis, in particular a Fourier transform of the signals transmitted by the photodetector 9. The Fourier transform may hereby be performed with approximately 64,000 sampling points in a time interval of approximately 1 ms.

The results of the Fourier transform can be evaluated by the computing unit and provide information about the mechanical stress and the mechanical parameters of the optical fiber 3 to be measured as a function of the propagation times of the frequency components and thus the locations in the optical fiber 3. For example, spatially resolved vibrations in the optical fiber 3 can be determined with this method. A spatial resolution of approximately 1 m can be attained with the devices of the invention and with the method of the invention, respectively.

The embodiment of FIG. 2 has only insignificant differences from the embodiment of FIG. 1.

As mentioned above, in the second embodiment, in contrast with the first embodiment, external tuning means 2 are provided. However, the first embodiment according to FIG. 1 may also be provided with external tuning means and the second embodiment according to FIG. 2 may be provided with internal tuning means.

In addition, in the second embodiment, an additional polarization beam splitter 13 is provided which is arranged after the beam combiner 8 and which separates the light to be measured into two portions depending on the polarization.

Accordingly, two photodetectors 9 and two A/D converters 11 are provided for each of the two components. The photodetectors 9 may include, for example, previously integrated amplifiers.

The signals from the two A/D converters 11 are supplied to the data processing unit 12 and Fourier-transformed in the data processing unit 12.

1. A method for spatially resolved measurement of mechanical vibrations, comprising the following steps:
generating light with a laser light source (1);
tuning the laser light source (1) within a time period of less than 50 ms;
coupling the light into an optical fiber (3);
coupling the portions of the light that were coupled into the optical fiber and are backscattered in the optical fiber (3) out of the optical fiber (3);
measuring the portions of the backscattered light coupled out of the optical fiber (3); and
evaluating the measured portions of the backscattered light for spatially resolved determination of at least one mechanical parameter of the optical fiber (3).

2. The method according to claim 1, wherein the tuning step causes beat signals which are evaluated.

3. The method according to claim 1, wherein the method is an OFDR method (Optical Frequency Domain Reflectometry).

4. The method according to claim 1, wherein the tuning step occurs within a time period of less than 10 ms.

5. The method according to claim 1, wherein the tuning range is between 0.1 GHz and 50 GHz.

6. The method according to claim 1, wherein the coupling step provides portions of the backscattered light coupled out of the optical fiber (3) which are measured with a sampling rate of at least 1 Ms/s.

7. The method according to claim 1, further comprising the step of evaluating the measured portions including a Fourier transform.

8. The method according to claim 7, the wherein the Fourier transform is performed with between 1024 and 131,072 sampling points.

9. The method according to claim 7, wherein the Fourier transform is performed in a time interval of less than 10 ms.

10. A device for spatially resolved measurement of mechanical parameters, comprising:
at least one optical fiber (3) for the spatially resolved measurement of at least one mechanical parameter;
at least one laser light source (1), the light of which is coupled into the optical fiber (3), wherein the portions of the light generated by the laser light source (1) and backscattered in the optical fiber (3) is coupled out of the optical fiber (3);
tuning means (2) capable of tuning the portions of the backscattered light coupled out of the optical fiber (3);
analyzer for determining from the measured portions of the backscattered light the at least one mechanical parameter of the optical fiber (3) with spatial resolution.

11. The device according to claim 10, wherein the laser light source (1) is constructed such that the bandwidth of the light emitted by the laser light source (1) is less than 500 kHz.

12. The device according to claim 10, wherein the laser light source (1) is constructed such that the coherence length of the light emitted by the laser light source (1) is longer than 1 km.

13. The device according to claim 10, wherein the analyzer comprises a digital signal processor (DSP) or a field programmable gate array (FPGA).

14. The device according to claim 13, wherein the analyzer comprises an A/D converter (11) arranged before the digital signal processor (DSP) or the field programmable gate array (FPGA).

15. The device according to claim 10, wherein the tuning means (2) comprise a wavelength modulator provided with a piezo-based control.

16. The method according to claim 4, wherein the tuning step occurs within a time period of less than 5 ms.

17. The method according to claim 4, wherein the tuning step occurs within a time period between 0.8 ms and 1.2 ms.

18. The method according to claim 5, wherein the tuning range is 0.5 GHz and 20 GHz.

19. The method according to claim 5, wherein the tuning range is between 1 GHz and 10 GHz.

20. The method according to claim 6, wherein the sampling rate is at least 10 Ms/s.

21. The method according to claim 6, wherein the sampling rate is at least 100 Ms/s.

22. The method according to claim 7, wherein the Fourier transform is performed with between 4096 and 65,536 sampling points.

22. The method according to claim 7, wherein the Fourier transform is performed with sampling points equal to 2ⁿ, with n=1, 2, 3, . . . .

23. The method according to claim 7, wherein the Fourier transform is performed in a time interval of less than 10 ms.

24. The method according to claim 7, wherein the Fourier transform is performed in a time interval of less than 2 ms.

25. The method according to claim 7, wherein the Fourier transform is performed in a time interval of between 0.2 ms and 1.0 ms.

26. The device for spatially resolved measurement of mechanical parameters according to claim 1, wherein the mechanical parameter are mechanical oscillations.

27. The device according to claim 11, wherein the bandwidth of the light emitted by the laser light source (1) is less than 200 kHz.

28. The device according to claim 12, wherein the bandwidth of the light emitted by the laser light source (1) is less than 100 kHz.

29. The device according to claim 12, wherein the laser light source (1) is longer than 5 km.

30. The device according to claim 12, wherein the laser light source (1) is between 10 km and 100 km long.

31. The device according to claim 15, wherein the wavelength modulator is a fiber Bragg grating (FBG).
